(19) United States
(12) Patent Application Publication
(10) Pub. No.: US 2016/0242039 A1
(43) Pub. Date: Aug. 18, 2016

(54) Methods, Computer Programs, Network Nodes and Communication Device

(71) Applicant: Telefonaktiebolaget L M Ericsson (publ), Stockholm (SE)

(72) Inventors: Oskar Drugge, Malmö (SE); Michael Breschel, Lund (SE); Sorour Falahati, Stockholm (SE); Daniel Larsson, Vallentuna (SE)

(21) Appl. No.: 14/433,935

(22) PCT Filed: Feb. 17, 2015
(86) PCT No.: PCT/EP2015/053340

§ 371 Date: Apr. 7, 2015

(51) Int. Cl. H04W 16/14; H04W 28/26; H04W 24/08

(52) U.S. Cl. CPC H04W 16/14; H04W 24/08; H04W 28/26; H04W 84/042

(57) ABSTRACT

A method of operating a network node arranged for cellular communication is disclosed. The network node is capable to operate according to a Radio Access Technology, RAT. The method comprises checking whether a channel in an unlicensed band is clear. If found that the channel is clear, the method proceeds with transmitting a reservation signal on the channel, transmitting data on the channel, and releasing the channel. The transmitting of the reservation signal further includes embedding information related to the transmitting entity and embedding information about scheduled recipient or recipients. The reservation signal may also include embedded information about a duration or end of the intended transmission. Methods for network nodes and communication devices, computer programs, network nodes and communication device are also disclosed.

### TECHNICAL FIELD

The present invention generally relates to an approach for operating in an unlicensed band.

### BACKGROUND

Cellular systems are often used for wireless broadband data, and for example 3^{rd} Generation Partnership Project, 3GPP, Long Term Evolution, LTE, is a platform that meets that demand. Existing and new spectrum licensed for exclusive use by cellular technologies will remain fundamental for providing seamless coverage, achieving spectral efficiency, and ensuring the reliability through careful planning of cellular networks and deployment of high-quality network equipment and devices.

However, it is a desire to meet increasing demand for wireless bandwidth.

### SUMMARY

An object of the invention is to at least alleviate the above stated problem. The present invention is based on the understanding that additional bandwidth may be achieved by using unlicensed band, but that this implies certain operations for fair sharing of the unlicensed band. The inventors have found that embedding some information in a reservation signal may enable reducing power consumption for entities.

According to a first aspect, there is provided a method of operating a network node arranged for cellular communication. The network node is capable to operate according to a Radio Access Technology, RAT. The method comprises checking whether a channel in an unlicensed band is clear. If found that the channel is clear, the method proceeds with transmitting a reservation signal on the channel, transmitting data on the channel, and releasing the channel. The transmitting of the reservation signal further includes embedding information related to the transmitting entity and embedding information about scheduled recipient or recipients.

The transmitting of the reservation signal may include embedding information about a duration or end of intended transmission.

A duration of a transmission on the channel, including the time for checking whether the channel is clear, transmitting the reservation signal and transmitting the data, may correspond to a predetermined number of 3GPP LTE subframes. The predetermined number may be four.

The embedding of information related to the transmitting entity may include information about a cell the network node is operating, an operator operating the network node, or a network identity, or a combination thereof.

The embedding of information about scheduled recipient or recipients may include information about a station scheduled for data transmission, or a scheduling group of stations scheduled for the data transmission, or a combination thereof.

The embeddings of information in the reservation signal may include encoding according to a Physical Downlink Control CHannel, PDCCH, symbol mechanism utilizing a dedicated Downlink Control Information, DCI, format therefor.

The embeddings of information in the reservation signal may include utilizing a single PDCCH symbol repeated for a plurality of or all symbols of the reservation signal. The PDCCH symbol may be combined with reference signals for an arbitrary number of transmission ports.

The embeddings of information in the reservation signal may include encoding the information to be embedded according to a predetermined coding scheme, and mapping the encoded information to one or more symbols.

The embeddings of information in the reservation signal may include indexing the information to be embedded into an orthogonal cover code, multiplying a baseline reservation signal with the orthogonal cover code, and mapping the encoded information to one or more symbols.

The embeddings of information in the reservation signal may include assigning a time-domain signal for any permutation of the information to be embedded, wherein the time-domain signal is a Constant Amplitude Zero AutoCorrelation, CAZAC, sequence with different cyclic shifts or indices for the permutations, and mapping the time-domain signal to one or more symbols.

The embeddings of information in the reservation signal may include repeating the mapped symbol for a plurality of or all symbols of the reservation signal.

The RAT may be 3GPP Long Term Evolution, LTE.

According to a second aspect, there is provided a method of operating a transceiver station arranged for cellular communication. The transceiver station is capable to operate according to a Radio Access Technology, RAT. The method comprising receiving a signal on a channel in an unlicensed band, and determining whether the signal is according to the RAT. If the signal is according to the RAT, the method proceeds with decoding at least a part of the signal, determining whether the signal is of interest for the transceiver station, and if the signal is not of interest for the transceiver station, turning off a receiver of the transceiver station.

The determining whether the signal is of interest for the transceiver station may include determining whether the signal comprises information indicating that it is transmitted from a serving cell of the transceiver station, or the signal comprises information indicating that the transceiver station is an intended recipient, or a combination thereof. The information indicating that the signal is transmitted from a serving cell of the transceiver station may include information about a cell identity, an operator operating the network, or a network identity, or a combination thereof.

The information indicating that the transceiver station is an intended recipient may include information about a station scheduled for data transmission, or a scheduling group of stations scheduled for the data transmission, or a combination thereof.

If the signal is not of interest for the transceiver station, the method may proceed with determining information about a duration or end of an intended transmission from the signal, and postponing turning on the receiver again until the intended transmission is ready. The determining of information about the duration or end of the intended transmission may comprise identifying the signal from information from the decoding to map to a predetermined duration or end of the intended transmission. The determining of information about the duration or end of the intended transmission may alternatively comprise reading explicit information about the duration or end of the intended transmission from the signal.

The RAT may be 3GPP Long Term Evolution, LTE.

According to a third aspect, there is provided a method of operating a network node arranged for cellular communication. The network node is capable to operate according to a Radio Access Technology, RAT. The method comprises receiving a signal on a channel in an unlicensed band, and determining whether the signal is according to the RAT. If the signal is according to the RAT, the method proceeds with decoding at least a part of the signal, determining whether the transmitting of the reservation signal includes embedded information about a duration or end of an intended transmission, and postponing monitoring of the channel again until the intended transmission is ready.

According to a fourth aspect, there is provided a network node arranged for cellular communication, wherein the network node is capable to operate according to a Radio Access Technology, RAT, and the network node comprises a transceiver and a controller, and is arranged to check whether a channel in an unlicensed band is clear, and if a signal is received on the channel determining whether the signal is according to the RAT, and if the signal is according to the RAT to decoding at least a part of the signal and determine whether the transmitting of the reservation signal includes embedded information about a duration or end of an intended transmission, wherein the network node is arranged to postpone monitoring of the channel again until the intended transmission is ready.

According to a fifth aspect, there is provided a network node arranged for cellular communication, wherein the network node is capable to operate according to a Radio Access Technology, RAT, and the network node comprises a transceiver and a controller, and is arranged to check whether a channel in an unlicensed band is clear, and if found that the channel is clear, the controller is arranged to cause the transceiver to transmit a reservation signal on the channel and transmit data on the channel, whereafter the controller is arranged to release the channel, wherein the reservation signal further includes embedded information related to the transmitting entity and embedded information about scheduled recipient or recipients.

The reservation signal may include embedded information about a duration or end of intended transmission.

A duration of a transmission on the channel, including the time for checking whether the channel is clear, transmitting the reservation channel and transmitting the data, may correspond to a predetermined number of 3GPP LTE subframes. The predetermined number may be four.

The embedded information related to the transmitting entity may include information about a cell the network node is operating, an operator operating the network node, or a network identity, or a combination thereof.

The embedded information about scheduled recipient or recipients may include information about a station scheduled for data transmission, or a scheduling group of stations scheduled for the data transmission, or a combination thereof.

The embedded information in the reservation signal may be encoded according to a Physical Downlink Control CHannel, PDCCH, symbol encoding utilizing a dedicated Downlink Control Information, DCI, format therefor.

The embedded information in the reservation signal may involve a single PDCCH symbol per subframe.

The embedded information in the reservation signal may involve a single PDCCH symbol repeated for a plurality of or all symbols of the reservation signal.

The PDCCH symbol may be combined with reference signals for an arbitrary number of transmission ports.

The embedded information in the reservation signal may include encoded information to be embedded according to a predetermined coding scheme mapped to one or more symbols.

The embedded information in the reservation signal may include indexed information to be embedded into an orthogonal cover code, wherein a baseline reservation signal multiplied with the orthogonal cover code, mapped to one or more symbols.

The embedded information in the reservation signal may include a time-domain signal assigned for any permutation of the information to be embedded, wherein the time-domain signal is a Constant Amplitude Zero AutoCorrelation, CAZAC, sequence with different cyclic shifts or indices for the permutations, mapped to one or more symbols.

The embedded information in the reservation signal may include the mapped symbol repeated for a plurality of or all symbols of the reservation signal.

The RAT may be 3GPP Long Term Evolution, LTE.

According to a sixth aspect, there is provided a transceiver station arranged for cellular communication, wherein the transceiver station is capable to operate according to a Radio Access Technology, RAT, and the transceiver station comprises a transceiver and a controller, and is arranged to receive a signal on a channel in an unlicensed band and determine whether the signal is according to the RAT, and if the signal is according to the RAT, the transceiver station is arranged to decode at least a part of the signal and determine whether the signal is of interest for the transceiver station, wherein if the signal is not of interest for the transceiver station, the controller is arranged to turn off a receiver of the transceiver.

The determination whether the signal is of interest for the transceiver station may be based on whether the signal comprises information indicating that it is transmitted from a serving cell of the transceiver station, or the signal comprises information indicating that the transceiver station is an intended recipient, or a combination thereof. The information indicating that the signal is transmitted from a serving cell of the transceiver station may include information about a cell identity, an operator operating the network, or a network identity, or a combination thereof.

The information indicating that the transceiver station is an intended recipient may include information about a station scheduled for data transmission, or a scheduling group of stations scheduled for the data transmission, or a combination thereof.

The controller may be arranged to, if the signal is not of interest for the transceiver station, determine information about a duration or end of an intended transmission from the signal, and postpone controlling of turning on the receiver again until the intended transmission is ready.

The RAT may be 3GPP Long Term Evolution, LTE.

According to a seventh aspect, there is provided a computer program comprising instructions which, when executed on one or more processors of a network node, causes the network node to perform the method according to any one of the first or third aspects.

According to an eighth aspect, there is provided a computer program comprising instructions which, when executed on one or more processors of a transceiver station, causes the transceiver station to perform the method according to the second aspect.

Other objectives, features and advantages of the present invention will appear from the following detailed disclosure, from the attached dependent claims as well as from the drawings. Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings.

FIG. 1 illustrates a time-frequency grid of a communication system

FIG. 2 illustrates subframes and radio frames.

FIG. 3 illustrates an example on downlink control signalling.

FIG. 4 illustrates CCE aggregation for different aggregation levels.

FIGS. 5-8 are a signal schemes illustrating operations in an unlicensed band.

FIGS. 9-11 are flow charts illustrating methods according to embodiments.

FIG. 12 is a block diagram illustrating a network node.

FIG. 13 is a block diagram illustrating a communication device.

FIG. 14 schematically illustrates a computer-readable medium and a processor.

### DETAILED DESCRIPTION

A number of abbreviations are used in this disclosure. Some of them are listed below, and others are explained as they appear in the text.

LAA Licensed Assisted Access

RS Reservation Signal

SG Scheduling group

LTE Long Term Evolution

UE User Equipment

LBT Listen Before Talk

SCell Secondary Cell

PCell Primary Cell

DFS Dynamic Frequency Selection

To meet ever increasing data traffic demand from users and, in particular, in concentrated high traffic buildings or hot spots, more mobile broadband bandwidth may be needed. Given the large amount of spectrum available in unlicensed bands, unlicensed spectrum may be considered as a complementary tool to augment service. While unlicensed spectrum may not match some qualities of the licensed regime, solutions that allow an efficient use of it as a complement to licensed deployments have the potential to bring value to the cellular operators.

Some of the examples given in this disclosure are made in light of the 3GPP LTE system. The invention may of course also be used for other systems in a similar way. For the understanding of some terms and principles referred to in some of the examples, a brief explanation of some features of the 3GPP LTE will be given.

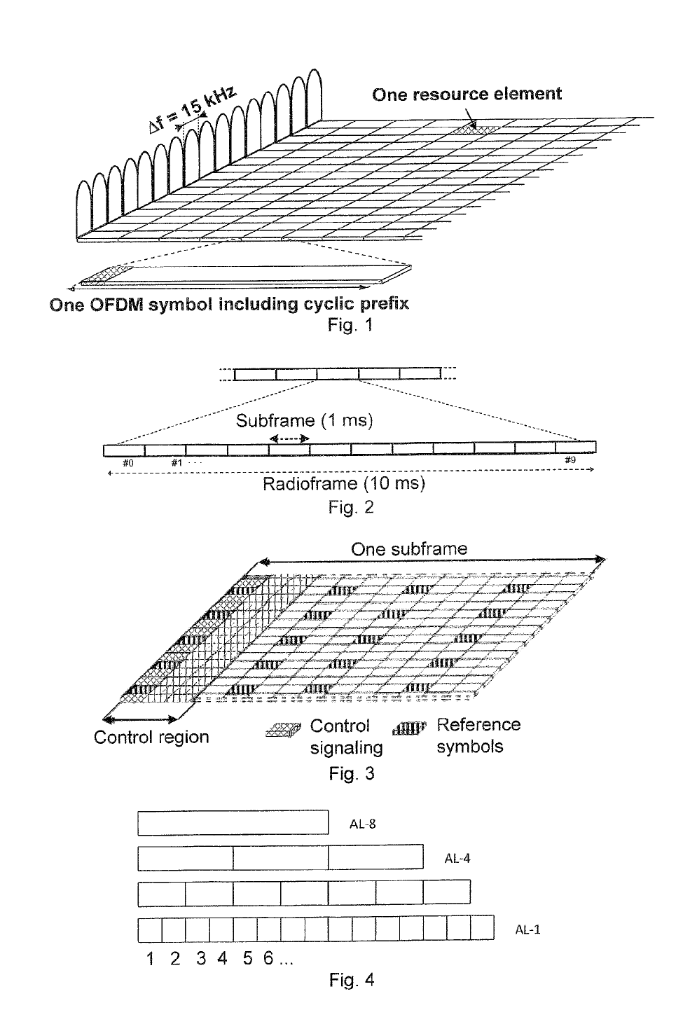

LTE uses OFDM in the downlink and DFT-spread OFDM in the uplink. The basic LTE downlink physical resource can thus be seen as a time-frequency grid as illustrated in FIG. 1 where each resource element corresponds to one OFDM subcarrier during one OFDM symbol interval.

FIG. 2 illustrates subframes and radio frames in LTE. In the time domain, LTE downlink transmissions are organized into radio frames of 10 ms, each radio frame consisting of ten equally-sized subframes of 1 ms.

Furthermore, the resource allocation in LTE is typically described in terms of resource blocks, where a resource block corresponds to one slot, with a duration of 0.5 ms, in the time domain and 12 contiguous subcarriers in the frequency domain. Resource blocks are numbered in the frequency domain, starting with 0 from one end of the system bandwidth.

Downlink and uplink transmissions are dynamically scheduled, i.e. in each subframe the base station transmits control information about to or from which terminals data is transmitted and upon which resource blocks the data is transmitted.

The control information to a given terminal is transmitted using one or multiple physical downlink control channels (PDCCH). A PDCCH is transmitted in the control region consisting of the first n=1, 2, 3 or 4 OFDM symbols in each subframe where n is the Control Format Indicator (CFI). Typically the control region consists of many PDCCH carrying control information to multiple terminals simultaneously. A downlink system with 3 OFDM symbols allocated for control signalling (for example the PDCCH) is illustrated in FIG. 3.

After channel coding, scrambling, modulation and interleaving of the control information, the modulated symbols are mapped to the resource elements in the control region. To multiplex multiple PDCCH onto the control region, control channel elements (CCE) has been defined, where each CCE maps to 36 resource elements. One PDCCH can, depending on the information payload size and the required level of channel coding protection, comprise 1, 2, 4 or 8 CCEs, and the number is denoted as the CCE aggregation level (AL). By choosing the aggregation level, link-adaptation of the PDCCH is obtained. In total there are N_{CCE} CCEs available for all the PDCCH to be transmitted in the subframe and the number N_{CCE} varies from subframe to subframe depending on the number of control symbols n.

As N_{CCE} varies from subframe to subframe, the terminal needs to blindly determine the position and the number of CCEs used for its PDCCH which can he a computationally intensive decoding task. Therefore, some restrictions in the number of possible blind decodings a terminal needs to go through have been introduced. For instance, the CCEs are numbered and CCE aggregation levels of size K can only start on CCE numbers evenly divisible by K, as illustrated in FIG. 4.

The set of CCE where a terminal needs to blindly decode and search for a valid PDCCH are called search spaces. This is the set of CCEs on an AL a terminal should monitor for scheduling assignments or other control information. In each subframe and on each AL, a terminal will attempt to decode all the PDCCHs that can be formed from the CCEs in its search space. If the CRC checks, then the content of the PDCCH is assumed to be valid for the terminal and it further processes the received information. Often will two or more terminals have overlapping search spaces and the network has to select one of them for scheduling of the control channel. When this happens, the non-scheduled terminal is said to be blocked. The search spaces vary pseudo-randomly from subframe to subframe to minimize this blocking probability.

A search space is further divided to a common and a terminal specific part. In the common search space, the PDCCH containing information to all or a group of terminals is transmitted (paging, system information etc). If carrier aggregation is used, a terminal will find the common search space present on the primary component carrier (PCC) only. The common search space is restricted to aggregation levels 4 and 8 to give sufficient channel code protection for all terminals in the cell (since it is a broadcast channel, link adaptation can not be used). The m₈ and m₄ first PDCCH (with lowest CCE number) in an AL of 8 or 4 respectively belong to the common search space. For efficient use of the CCEs in the system, the remaining search space is terminal specific at each aggregation level.

A CCE comprises 36 QPSK modulated symbols that map to the 36 resource elements (REs) unique for this CCE. To maximize the diversity and interference randomization, interleaving of all the CCEs is used before a cell specific cyclic shift and mapping to REs. This may include structuring all PDCCHs into CCE, scrambling and modulating, possibly layer mapping for transmit diversity, interleaving based on quadruplex, cyclically shiftning based on cell identity and mapping to resource element groups. Note that in most cases are some CCEs empty due to the PDCCH location restriction to terminal search spaces and aggregation levels. The empty CCEs are included in the interleaving process and mapping to RE as any other PDCCH to maintain the search space structure. Empty CCE are set to zero power and this power can instead be used by non-empty CCEs to further enhance the PDCCH transmission.

Furthermore, to enable the use of 4 antenna TX diversity, a group of 4 adjacent QPSK symbols in a CCE is mapped to 4 adjacent RE, denoted a RE group (REG). Hence, the CCE interleaving is quadruplex (group of 4) based and mapping process has a granularity of 1 REG and one CCE corresponds to 9 REGs (=36 RE).

There will also in general be a collection of REG that remains as leftovers after the set of size N_{CCE} CCEs has been determined (although the leftover REGs are always fewer than 36 RE) since the number of REGs available for PDCCH in the system bandwidth is in general not an even multiple of 9 REGs. These leftover REGs are in LTE unused by the system.

The information carried on the PDCCH is called downlink control information (DCI). Depending on the configured transmission mode (a UE is configured in one uplink and one downlink transmission mode), and the purpose of the message, the content of the DCI varies. As an example, an uplink MIMO transmission is scheduled using DCI format 4 and contains the necessary information about where the UE shall transmit the uplink data, i.e. the resource block assignment, which precoding matrix to use, which reference signal to use, etc. The corresponding downlink DCI format is format 2C. The size of each DCI format depends on the system bandwidth and reaches in this example 66 bits for DCI format 2C.

For example, Licensed-Assisted Access, LAA, technologies has been studied in 3GPP, wherein an LAA framework is suggested to build on the carrier aggregation solutions to access additional bandwidth in the unlicensed band. For example, it is suggested that the LTE network can configure a User Equipment, UE, to aggregate additional secondary cells, SCells, (Cf. primary cells, PCells, which use a licensed spectrum) which are using the frequency carriers in the unlicensed band. The PCell may retain the exchange of essential control messages and also provide always-available robust spectrum for real-time or high-value traffic. The PCell may also provide mobility handling and management for the UE via the high-quality licensed band LTE radio access network with wide coverage. The aggregated SCells in the unlicensed band, when available, can be utilized as bandwidth booster to serve, e.g., best effort traffic. The LAA SCell may operate in downlink, DL, only mode or operate with both uplink, UL, and DL traffic.

The unlicensed spectrum in general allows non-exclusive use. Given the widespread deployment and usage of other technologies in unlicensed spectrum for wireless communications, it is envisioned that cellular systems such as the LTE would have to coexist with existing and future uses of unlicensed spectrum. Some regulatory regime adopts a technology-neutral coexistence policy. For operating a cellular system such as the LTE in unlicensed spectrum, an approach is to check whether an unlicensed channel is unused before commencing a transmission, often referred to as listen-before-talk, LBT.

The LBT procedure is defined as a mechanism by which equipment applies a clear channel assessment, CCA, check before using the channel. The CCA utilizes at least energy detection to determine the presence or absence of other signals on a channel in order to determine if a channel is occupied or clear, respectively. Some national or regional regulations mandate the usage of LBT in the unlicensed bands. Apart from regulatory requirements, carrier sensing via LBT will lead to fair sharing of the unlicensed spectrum and hence it is considered to be an important feature for fair and friendly operation in the unlicensed spectrum.

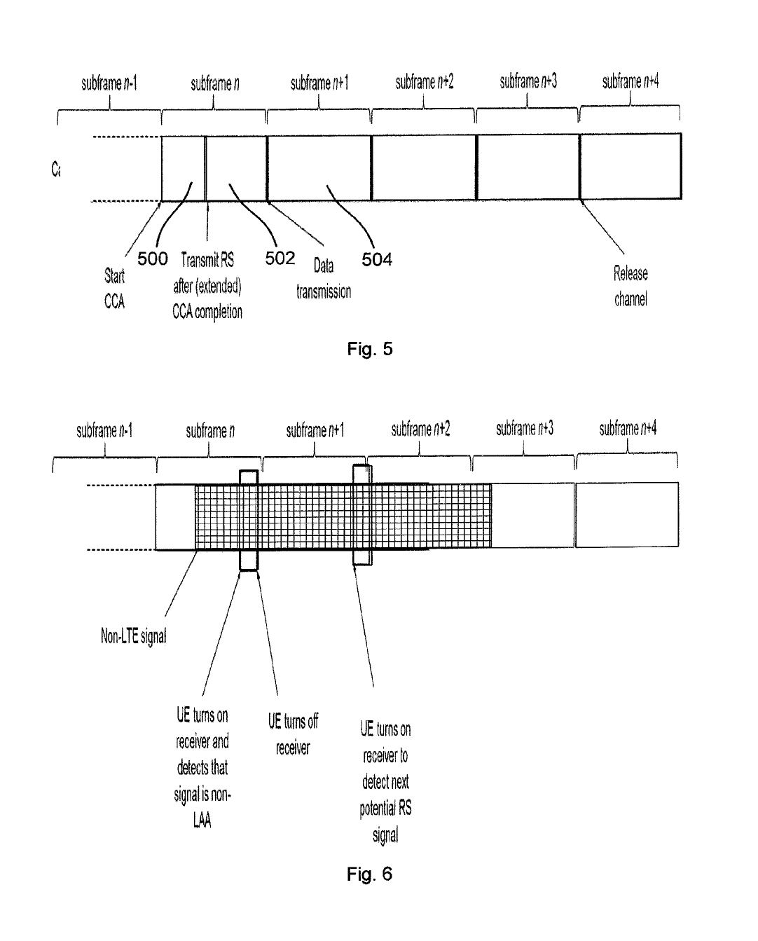

FIG. 5 is an example of a signal scheme illustrating operations in an unlicensed band. For example, an eNodeB starts the LBT procedure by e.g. measuring 500 to obtain received signal strength indicator, RSSI, of the channel at the beginning of a subframe n. Somewhere during the subframe n, e.g. during a predetermined first part of the subframe, LBT procedure succeeds and the eNodeB starts transmitting 502 a signal in order to make sure to reserve the channel from usage by other equipment that also employs LBT, i.e. a reservation signal. At the beginning of subframe n+1, the eNodeB starts transmission 504 of a data-burst with a predetermined or configurable duration; in the example the duration is three subframes. The reservation signal, RS, which for the purpose of achieving a reservation of the channel, could be random data with sufficiently high energy to enable other equipment, applying the similar LBT procedure, to refrain from transmitting in the unlicensed channel at the same time.

Since the UE could be scheduled a data burst that starts at any of the sub-frame borders, the UE needs to receive and process every sub-frame to determine whether it was a valid transmission from it's serving cell to itself or if it was any other transmission. Because of this continuous reception and processing at the UE, the power consumption may be high.

Several operators may simultaneously use the unlicensed spectrum and they may or may not synchronize their transmissions.

A cellular network operating in the unlicensed band may enable UEs, and also other network nodes to save energy by providing additional information embedded in for example the reservation signal, from which the UEs may gain knowledge that no transmission is intended for them during the upcoming transmission, or the other network nodes may gain knowledge that the channel will be occupied during the upcoming transmission. They may thus save energy by omitting monitoring activities during the upcoming transmission.

Consider a receiving station, e.g. a UE capable of communicating according to the LTE, starting its receiver a few symbols before a subframe boundary.

FIG. 6 illustrates an example where the received signal is processed and classified as a non-LTE signal. Here, the station may turn off its receiver and start reception a few symbols before the next subframe and save that corresponding amount of power.

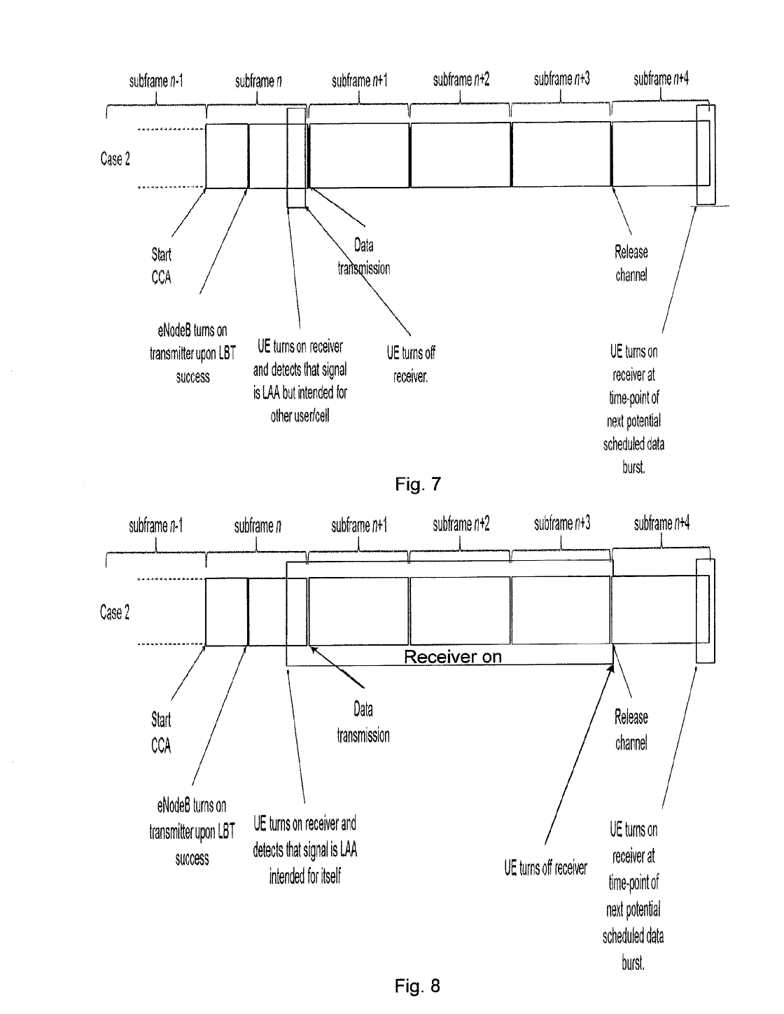

FIG. 7 illustrates an example where the received signal is processed and classified as a reservation signal from a non-serving cell, i.e. comprising no transmission to the station. The station may here turn off the receiver for a duration of one data burst to save power.

FIG. 7 may also illustrate an example where the received signal is processed and classified as a reservation signal from the serving cell. The station also determines that the signal is only scheduled for other stations, and may turn off the receiver for a duration of one data burst to save power.

FIG. 8 illustrates an example where the received signal is processed and classified as a reservation signal from the serving cell. The station also determines that it is scheduled. The station thus keeps the receiver on and receives the data of the data burst.

Note that if information about which UEs that are scheduled is embedded in the form scheduling groups, the design could allow that only a few of the UEs in a scheduling group actually are scheduled. Those UEs belonging to a scheduling group indicated in the received reservation signal would of course keep their receivers on and not save power, but there would still be a potential for power-save for those UEs belonging to other scheduling groups.

The proposed design of reservation signal allows the UE to save power by only turning on for a few symbols, say 2-5 symbols, out of a total data burst with a length in the order of 14*4 symbols whenever it is not scheduled. The receiver could therefore in an extreme case be turned off for in the order of 90% of the time compared to existing solutions. Upon the start of scheduling of an upcoming data-transmission in a LAA system, a scheduling algorithm residing in a network node determines which UE will, or may be, scheduled in either the upcoming sub-frame, or the upcoming set of sub-frames contained in the upcoming transmission. The following information may then be prepared to be transmitted in a signalling message from the network node to the UE:

A two-dimensional bitmap indicating which UE:s or scheduling groups, that will or may be scheduled per each potential sub-frame in the upcoming transmission.

A real number, or an index from a predetermined set of configurable alternatives, indicating the length, e.g. in sub-frames, of the upcoming transmission. Alternatively the transmission length is implicitly deduced from the size of the two-dimensional bitmap in case its size is designed to be dynamically changing with the transmission length.

A real number indicating an operator id, so as to aid the UE in distinguishing which operator the transmitting network node belongs to.

For example, consider the following assumptions:

> Assume nrof_SE Scheduling Identities (UE:s or groups of UE:s) can be scheduled

—Assume to use a bit-map type of addressing, i.e. Nrof SE bits required to make it flexible to address one or many scheduling identities per transmission time interval, TTI.

—Assume support for nrof_operators operator ID:s

—Assume the operator to be semi-static.

> Assume nrof_bits_operatorID bits required for identifying the operator.

> Assume nrof_tl_alternatives transmission length alternatives e.g. 4, 6, or 8 sub-frames, and max_transmission_length to be the alternative with the highest value, i.e. the longest duration.

the message would then for example comprise of the following information entities,

Scheduling information bitmap (nrof_SE* max_transmission_length)

Transmission length (log2(tl_alternatives) bits)

Operator ID (nrof_bits_operator ID bits).

From this, a number of variants of solutions may be provided. For example, the message bits may be encoded using existing PDCCH processing, as described above, but using a new DCI format that only contains the information mentioned above. Another example is that a single PDCCH symbol is used (CFI=1). This single symbol may comprise one or more PDCCH transmissions that can be combined with reference signals for an arbitrary number of transmission ports. The single symbol can further be transmitted every OFDM symbol from the point in time that LBT succeeds at the eNodeB transmitter, serving to both reserve the channel as well as info in the UEs about upcoming scheduling so that UEs not scheduled can turn off their receivers and save power. Another example is that the message bits are encoded using a generic coding scheme such as time/frequency block coding, convolutional coding, etc., and then mapped to resource elements in a single LTE symbol which is repeated from the point in time that LBT succeeds at the eNodeB. Still another example is that any baseline reservation signal is multiplied with an orthogonal cover code with a length long enough to index the different permutations that convey the information, prior to being mapped to resource elements in a single LTE symbol which is repeated from the point in time that LBT succeeds at the eNodeB. Further still another example is that the information is conveyed by assigning a time-domain signal to each permutation of the information bits such as e.g. a constant amplitude zero autocorrelation (CAZAC) sequence such as a Zadoff-Chu sequence with different cyclic shifts and q index. The UE can decode the message e.g. by performing time-domain correlation with each pre-defined signal alternative.

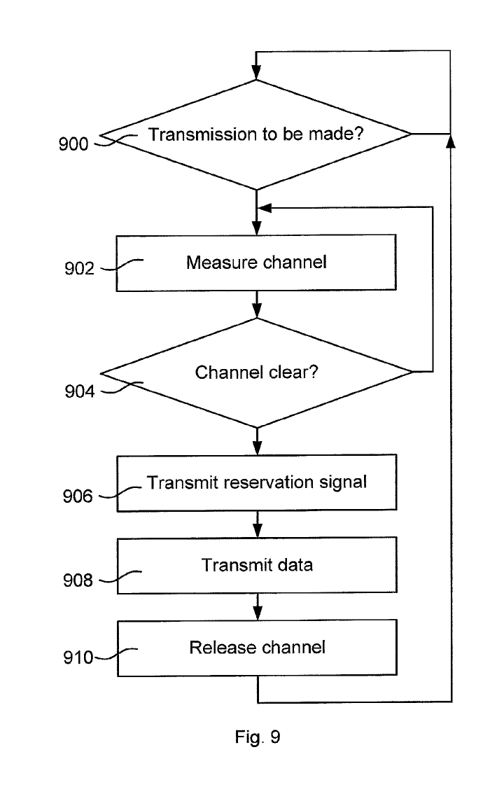

FIG. 9 is a flow chart illustrating a method of operating a network node according to an embodiment. The network node is arranged for cellular communication according to a radio access technology (RAT), e.g. the LTE. The network node considers 900 whether a transmission is to be made in an unlicensed band. If so, the network node measures 902 the channel in the unlicensed band, and based on that the network node can check 904 whether the channel is clear. If not clear, the network node needs to continue monitoring 902 the channel If the channel is clear, the network node starts transmitting 906 a reservation signal, and when timing is correct for a data burst, the network node transmits 908 data, and at end of the data burst, the network node releases 910 the channel. The transmitting 906 of the reservation signal includes embedding information related to the transmitting entity, and embedding information about scheduled recipient or recipients. The information may for example include an identification or flag for each TTI of the data burst that is scheduled for respective recipient. Alternatively, the information may include an identification or flag for each recipient indicating whether it is scheduled for any of the TTIs of the data burst, i.e. with a more coarse indication than in the previous example. Other examples of granularity of the information are equally feasible. The encoding of the information may follow approaches for other control information that are applied in the control signalling between the network node and the recipients. The transmitting 906 of the reservation signal may also include embedding information about a duration or end of intended transmission. The duration of the data burst, including the time for checking whether the channel is clear, transmitting 906 the reservation signal and transmitting the data, may correspond to a predetermined number of 3GPP LTE subframes. The predetermined number may for example be four since the occupied time of the channel then does not exceed 4 ms and thus fulfils for example Japanese regulations. The embedded information may include information about a cell the network node is operating, an operator operating the network node, etc., and/or information about scheduled recipient or recipients, e.g. information about a station scheduled for data transmission, a scheduling group of stations scheduled for the data transmission, etc. The embeddings of information in the reservation signal may include encoding according to a Physical Downlink Control CHannel, PDCCH, symbol mechanism utilizing a dedicated Downlink Control Information, DCI, format therefor. The solution may include utilizing a single PDCCH symbol per subframe. For example, embeddings of information in the reservation signal includes utilizing a single PDCCH symbol repeated for a plurality of or all symbols of the reservation signal. The PDCCH symbol may be combined with reference signals for an arbitrary number of transmission ports.

The embeddings of information in the reservation signal may include encoding the information to be embedded according to a predetermined coding scheme and mapping the encoded information to one or more symbols.

The embeddings of information in the reservation signal may include indexing the information to be embedded into an orthogonal cover code, multiplying a baseline reservation signal with the orthogonal cover code, and mapping the encoded information to one or more symbols.

The embeddings of information in the reservation signal may include assigning a time-domain signal for any permutation of the information to be embedded, wherein the time-domain signal is a Constant Amplitude Zero AutoCorrelation, CAZAC, sequence with different cyclic shifts or indices for the permutations, and mapping the time-domain signal to one or more symbols.

The embeddings of information in the reservation signal may include repeating the mapped symbol for a plurality of or all symbols of the reservation signal.

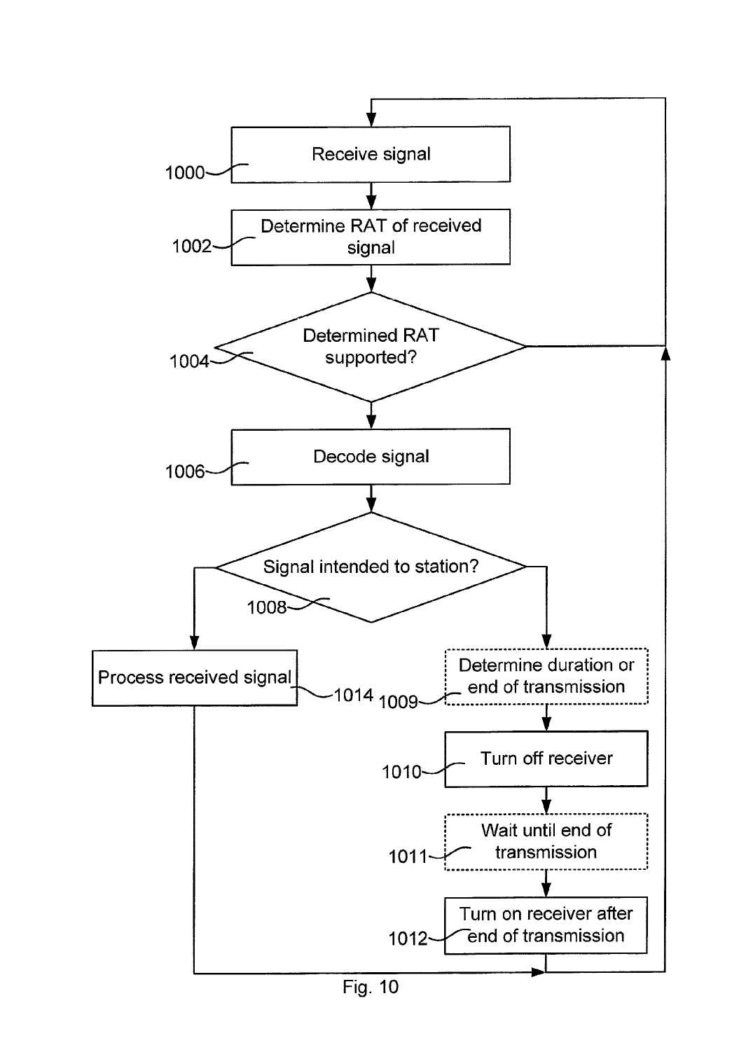

FIG. 10 is a flow chart illustrating a method of operating a transceiver station, e.g. a UE, according to an embodiment. The transceiver station is arranged to operate according to a RAT, e.g. the LTE. The station receives 1000 a signal on a channel of an unlicensed band. The station determines 1002 the RAT of the signal, and checks 1004 whether the signal is according to the RAT of the station. If not, the station continues to monitor the channel according to its previously used scheme. If the signal is according to the RAT of the station, the station decodes 1006 at least a part of the signal such that it is able to determine 1008 whether the signal is intended for the station. If it is, the receiver is kept on and the transmission is received and processed 1014. If it isn't, the receiver of the station is turned off 1010 to save power until the receiver is to be turned on 1012 again for monitoring the channel. Optionally, the station determines 1009 from the decoded signal the duration of the transmission, i.e. data burst, or a time when the transmission is about to end. The station is then able to wait 1011 until it knows that the transmission is ended before turning on 1012 the receiver again.

The determination 1008 whether the signal is of interest for the transceiver station includes for example determining whether the signal comprises information indicating that it is transmitted from a serving cell of the transceiver station, and/or the signal comprises information indicating that the transceiver station is an intended recipient. The information indicating that the signal is transmitted from a serving cell of the transceiver station may for example include information about a cell identity, an operator operating the network, a network identity, etc. The information indicating that the transceiver station is an intended recipient may for example include information about a station scheduled for data transmission, a scheduling group of stations scheduled for the data transmission, etc.

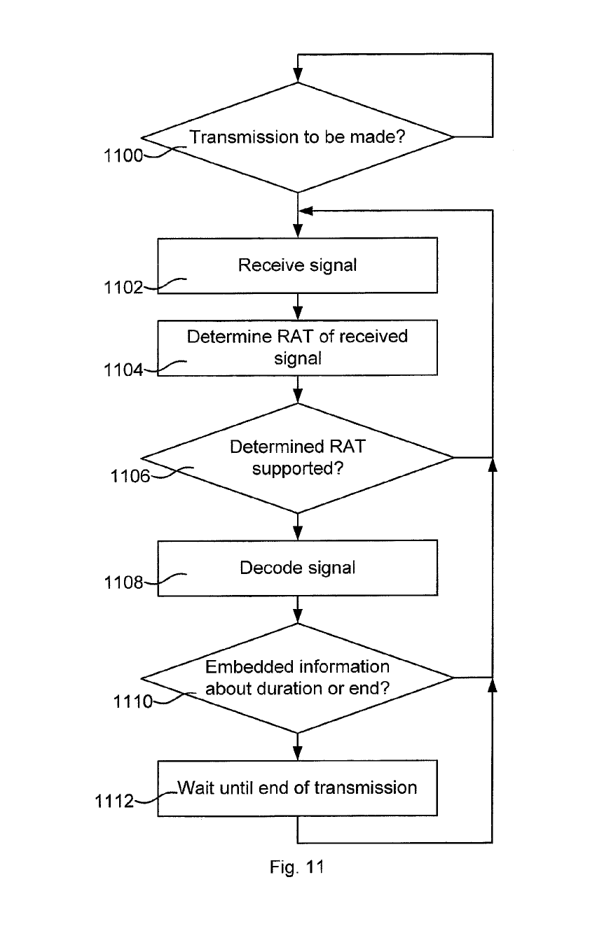

FIG. 11 is a flow chart illustrating a method of operating a network node according to an embodiment. Here, it is not about the network node forming a reservation signal, but instead an aid for a network node monitoring a channel. That is, the network node which may want to make a transmission 1100 monitors the channel on the unlicensed band by receiving 1102 a signal on a channel in the unlicensed band, and when there is found to be a signal or transmission present on the channel, the network node determines 1104 whether the signal is according to the RAT of the network node, and, when checking 1106, if the signal is not according to the RAT, the network node continues to monitor the channel according to its previously used scheme. If the signal is according to the RAT, the network node decodes 1108 at least a part of the signal, wherein it is enabled to determine 1110 whether the transmitting of the reservation signal includes embedded information about a duration or end of an intended transmission. If there is such information, the network node postpones 1112 monitoring of the channel again until the intended transmission is ready. The network node may thus also save resources, e.g. power, receiver resources, processing power, etc.

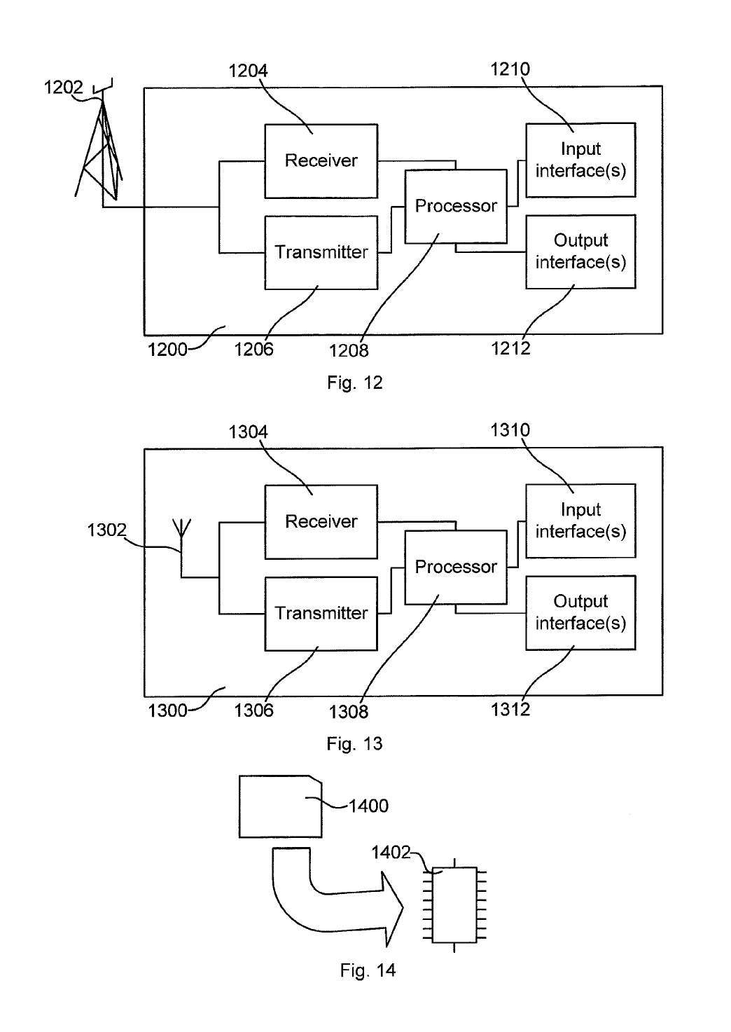

FIG. 12 is a block diagram schematically illustrating a network node 1200 connected to an antenna arrangement 1202, e.g. an antenna array. The network node 1200 comprises a receiver 1204 connected to the antenna arrangement 1202, a transmitter 1206 connected to the antenna arrangement 1202, a processing element 1208 which may comprise one or more circuits, one or more input interfaces 1210 and one or more output interfaces 1212. The interfaces 1210, 1212 can be user interfaces and/or signal interfaces, e.g. electrical or optical. The network node 1200 may be arranged to operate in a wireless cellular communication network. The network node 1200 may be a station as demonstrated above, i.e. base station, cluster head, etc. The processing element 1208 implements a controller of the network node, and is arranged to enable the method for operating a network node as demonstrated above. The processing element may also be involved in controlling the interfaces 1210, 1212, executing applications, e.g. for signalling operations, etc.

FIG. 13 is a block diagram schematically illustrating a communication device 1300 comprising an antenna arrangement 1302, e.g. an antenna array, a receiver 1304 connected to the antenna arrangement 1302, a transmitter 1306 connected to the antenna arrangement 1302, a processing element 1308 which may comprise one or more circuits, one or more input interfaces 1310 and one or more output interfaces 1312. The interfaces 1310, 1312 can be user interfaces and/or signal interfaces, e.g. electrical or optical. The communication device 1300 may be arranged to operate in a wireless cellular communication network. The communication device 1300 may be a transceiver station as demonstrated above, i.e. terminal, cluster head, UE, mobile communication device, etc. The processing element 1308 implements a controller of the communication device, and is arranged to enable the method for operating a transceiver station as demonstrated above. The processing element may also be involved in controlling the interfaces 1310, 1312, executing applications, signalling operations, etc.

The methods according to the present invention are suitable for implementation with aid of processing means, such as computers and/or processors, especially for the case where the network node or transceiver station is controlled by a processor. Therefore, there is provided computer programs, comprising instructions arranged to cause the processing means, processor, or computer to perform the steps of any of the methods according to any of the embodiments described above. The computer programs preferably comprises program code which is stored on a computer readable medium 1400, as illustrated in FIG. 14, which can be loaded and executed by a processing means, processor, or computer 1402 to cause it to perform the methods, respectively, according to embodiments of the present invention, preferably as any of the embodiments described above. The computer 1402 and computer program product 1400 can be arranged to execute the program code sequentially where actions of the any of the methods are performed stepwise. The processing means, processor, or computer 1402 is preferably what normally is referred to as an embedded system. Thus, the depicted computer readable medium 1400 and computer 1402 in FIG. 14 should be construed to be for illustrative purposes only to provide understanding of the principle, and not to be construed as any direct illustration of the elements.

The invention has mainly been described above with reference to a few embodiments. However, as is readily appreciated by a person skilled in the art, other embodiments than the ones disclosed above are equally possible within the scope of the invention, as defined by the appended patent claims.

1-46. (canceled)

47. A method of operating a network node configured for cellular communication, wherein the network node is configured to operate according to a Radio Access Technology (RAT), the method comprising:
checking whether a channel in an unlicensed band is clear, and when found that the channel is clear:
transmitting a reservation signal on the channel, wherein the transmitting of the reservation signal further includes embedding information related to the network node and embedding information about scheduled recipient or recipients;
transmitting data on the channel; and
releasing the channel.

48. The method of claim 47, wherein the transmitting of the reservation signal further includes embedding information about a duration or end of an intended transmission.

49. The method of claim 48, wherein a duration of a transmission on the channel:
includes the time for checking whether the channel is clear, transmitting the reservation signal and transmitting the data; and
corresponds to a predetermined number of 3GPP LTE subframes.

50. The method of claim 49, wherein the predetermined number is four.

51. The method of claim 47, wherein the embedding of information related to the transmitting entity includes information about:
a cell in which the network node is operating;
an operator operating the network node;
a network identity; or
a combination thereof.

52. The method of claim 47, wherein the embedding of information about scheduled recipient or recipients includes information about:
a station scheduled for data transmission;
a scheduling group of stations scheduled for the data transmission; or
a combination thereof.

53. The method of claim 47, wherein the embedding of information in the reservation signal includes:
encoding the information to be embedded according to a predetermined coding scheme; and
mapping the encoded information to one or more symbols.

54. The method of claim 47, wherein the embedding of information in the reservation signal includes:
indexing the information to be embedded into an orthogonal cover code;
multiplying a baseline reservation signal with the orthogonal cover code; and
mapping the product to one or more symbols.

55. The method of claim 47, wherein the embedding of information in the reservation signal includes:
assigning a time-domain signal for any permutation of the information to be embedded, wherein the time-domain signal is a Constant Amplitude Zero AutoCorrelation (CAZAC) sequence with different cyclic shifts or indices for the permutations; and
mapping the time-domain signal to one or more symbols.

56. The method of claim 47, wherein the embedding of information in the reservation signal further includes:
mapping to one or more symbols; and
repeating the mapped symbol for a plurality of or all symbols of the reservation signal,
wherein the mapping comprising any of the following:
encoding the information to be embedded according to a predetermined coding scheme; and mapping the encoded information to one or more symbols.
indexing the information to be embedded into an orthogonal cover code; multiplying a baseline reservation signal with the orthogonal cover code; and mapping the product to one or more symbols; or
assigning a time-domain signal for any permutation of the information to be embedded, wherein the time-domain signal is a Constant Amplitude Zero AutoCorrelation (CAZAC) sequence with different cyclic shifts or indices for the permutations; and mapping the time-domain signal to one or more symbols.

57. The method of claim 47, wherein the embedding of information in the reservation signal includes encoding according to a Physical Downlink Control Channel (PDCCH) symbol mechanism utilizing a dedicated Downlink Control Information (DCI) format therefor.

58. The method of claim 57, wherein the embedding of information in the reservation signal includes utilizing a single PDCCH symbol repeated for a plurality of or all symbols of the reservation signal.

59. The method of claim 57, wherein the PDCCH symbol is combined with reference signals for an arbitrary number of transmission ports.

60. The method of claim 57, wherein the RAT is 3GPP Long Term Evolution (LTE).

61. A method of operating a transceiver station configured for cellular communication, wherein the transceiver station is configured to operate according to a Radio Access Technology (RAT), the method comprising:
receiving a signal on a channel in an unlicensed band;
determining whether the signal is according to the RAT, and when the signal is according to the RAT:
decoding at least a part of the signal;
determining whether the signal is of interest for the transceiver station; and
if the signal is not of interest for the transceiver station, turning off a receiver of the transceiver station.

62. The method of claim 61, wherein the determining whether the signal is of interest for the transceiver station includes determining whether:
the signal comprises information indicating that it is transmitted from a serving cell of the transceiver station;
the signal comprises information indicating that the transceiver station is an intended recipient, or
a combination thereof.

63. The method of claim 62, wherein the information indicating that the signal is transmitted from a serving cell of the transceiver station includes information about:
a cell identity;
an operator operating the network;
a network identity; or
a combination thereof.

64. The method of claim 62, wherein the information indicating that the transceiver station is an intended recipient includes information about:
a station scheduled for data transmission;
a scheduling group of stations scheduled for the data transmission; or
a combination thereof.

65. The method of claim 61, further comprising, if the signal is not of interest for the transceiver station:
determining information about a duration or end of an intended transmission from the signal; and
postponing turning on the receiver again until the intended transmission is ready.

66. The method of claim 65, wherein the determining of information about the duration or end of the intended transmission comprises:
identifying the signal from information from the decoding to map to a predetermined duration or end of the intended transmission, or
reading explicit information about the duration or end of the intended transmission from the signal.

67. The method of claim 61, wherein the RAT is 3GPP Long Term Evolution (LTE).

68. A method of operating a network node configured for cellular communication, wherein the network node is configured to operate according to a Radio Access Technology (RAT), the method comprising:
receiving a reservation signal on a channel in an unlicensed band;
determining whether the signal is according to the RAT, and when the signal is according to the RAT:
decoding at least a part of the signal;
determining whether the the signal includes embedded information about a duration or end of an intended transmission; and
postponing monitoring of the channel again until the intended transmission is ready.

69. A network node configured for cellular communication, wherein the network node is configured to operate according to a Radio Access Technology (RAT) and comprises a transceiver and a controller, the network node is configured to:
check whether a channel in an unlicensed band is clear; and
when a reservation signal is received on the channel, determine whether the signal is according to the RAT;
and when the signal is according to the RAT
decode at least a part of the signal;
determine whether the transmitting of the signal indicates information about a duration or end of an intended transmission, and
postpone monitoring of the channel again until the intended transmission is ready.

70. The network node of claim 69, wherein to determine whether information about the duration or end of the intended transmission includes:
to identify the signal from the decoded at least a part of the signal and to map the identified signal to a predetermined duration or end of the intended transmission; or
to read explicit information about the duration or end of the intended transmission from the decoded at least a part of the signal.

71. A network node configured for cellular communication, wherein the network node is configured to operate according to a Radio Access Technology (RAT) and comprises a transceiver and a controller, the network node is configured to check whether a channel in an unlicensed band is clear, and when found that the channel is clear, the controller is configured to:
cause the transceiver to transmit a reservation signal on the channel and transmit data on the channel;
whereafter release the channel, wherein the reservation signal further includes embedded information related to the network node and embedded information about scheduled recipient or recipients.

72. The network node of claim 71, wherein the reservation signal further includes embedded information about a duration or end of an intended transmission.

73. The network node of claim 72, wherein a duration of a transmission on the channel:
includes the time for checking whether the channel is clear, transmitting the reservation channel and transmitting the data; and
corresponds to a predetermined number of 3GPP LTE subframes.

74. The network node of claim 73, wherein the predetermined number is four.

75. The network node of claim 71, wherein the embedded information related to the transmitting entity includes information about:
a cell in which the network node is operating;
an operator operating the network node;
a network identity; or
a combination thereof.

76. The network node of claim 71, wherein the embedded information about scheduled recipient or recipients includes information about:
a station scheduled for data transmission;
a scheduling group of stations scheduled for the data transmission; or
a combination thereof.

77. The network node of claim 71, wherein the embedded information in the reservation signal includes encoded information to be embedded according to a predetermined coding scheme mapped to one or more symbols.

78. The network node of claim 71, wherein the embedded information in the reservation signal includes indexed information to be embedded into an orthogonal cover code, wherein the orthogonal cover code is configured to be multiplied with a baseline reservation signal and the product mapped to one or more symbols.

79. The network node of claim 71, wherein the embedded information in the reservation signal includes a time-domain signal assigned for any permutation of the information to be embedded, wherein the time-domain signal is a Constant Amplitude Zero AutoCorrelation (CAZAC) sequence with different cyclic shifts or indices for the permutations, mapped to one or more symbols.

80. The network node of claim 71, wherein the embedded information in the reservation signal further includes a mapped symbol repeated for a plurality of or all symbols of the reservation signal; wherein the mapping of the mapped symbol comprises any of the following:
encoding the information to be embedded according to a predetermined coding scheme; and mapping the encoded information to one or more symbols;
indexing the information to be embedded into an orthogonal cover code; multiplying a baseline reservation signal with the orthogonal cover code; and mapping the product to one or more symbols; or
assigning a time-domain signal for any permutation of the information to be embedded, wherein the time-domain signal is a Constant Amplitude Zero AutoCorrelation (CAZAC) sequence with different cyclic shifts or indices for the permutations;
and mapping the time-domain signal to one or more symbols.

81. The network node of claim 71, wherein the embedded information in the reservation signal is encoded according to a Physical Downlink Control Channel (PDCCH) symbol encoding utilizing a dedicated Downlink Control Information (DCI) format therefor.

82. The network node of claim 81, wherein the embedded information in the reservation signal involves a single PDCCH symbol repeated for a plurality of or all symbols of the reservation signal.

83. The network node of claim 82, wherein the PDCCH symbol is combined with reference signals for an arbitrary number of transmission ports.

84. The network node of claim 71, wherein the RAT is 3GPP Long Term Evolution (LTE).

85. A transceiver station configured for cellular communication, wherein the transceiver station is configured to operate according to a Radio Access Technology (RAT), comprises a transceiver and a controller, and is configured to receive a signal on a channel in an unlicensed band and determine whether the signal is according to the RAT, and when the signal is according to the RAT:
the transceiver station is configured to decode at least a part of the signal and determine whether the signal is of interest for the transceiver station; and
wherein if the signal is not of interest for the transceiver station, the controller is configured to turn off a receiver of the transceiver.

86. The transceiver station of claim 85, wherein the determination whether the signal is of interest for the transceiver station is based on whether:
the signal comprises information indicating that it is transmitted from a serving cell of the transceiver station;
the signal comprises information indicating that the transceiver station is an intended recipient; or
a combination thereof.

87. The transceiver station of claim 86, wherein the information indicating that the signal is transmitted from a serving cell of the transceiver station includes information about:
a cell identity;
an operator operating the network;
a network identity; or
a combination thereof.

88. The transceiver station of claim 86, wherein the information indicating that the transceiver station is an intended recipient includes information about:
a station scheduled for data transmission;
a scheduling group of stations scheduled for the data transmission; or
a combination thereof.

89. The transceiver station of claim 85, wherein the controller is configured to, if the signal is not of interest for the transceiver station:
determine information about a duration or end of an intended transmission from the signal; and
postpone controlling of turning on the receiver again until the intended transmission is ready.

90. The transceiver station of claim 85, wherein the RAT is 3GPP Long Term Evolution (LTE).

91. A computer program product for operating a network node configured for cellular communication, wherein the network node is configured to operate according to a Radio Access Technology (RAT), the computer program product stored on a non-transitory, computer readable medium and comprising program instructions, which when executed by at least one processor, cause the at least one processor to:
check whether a channel in an unlicensed band is clear, and when found that the channel is clear:
transmit a reservation signal on the channel, wherein the transmitting of the reservation signal further includes embedding information related to the network node and embedding information about scheduled recipient or recipients;
transmit data on the channel; and
release the channel.

92. A computer program product for operating a transceiver station configured for cellular communication, wherein the transceiver station is configured to operate according to a Radio Access Technology (RAT), the computer program product stored on a non-transitory, computer readable medium and comprising program instructions, which when executed by at least one processor, cause the at least one processor to:
receive a signal on a channel in an unlicensed band;
determine whether the signal is according to the RAT, and when the signal is according to the RAT:
decode at least a part of the signal;
determine whether the signal is of interest for the transceiver station; and
if the signal is not of interest for the transceiver station, turn off a receiver of the transceiver station.

93. A computer program product for operating a network node configured for cellular communication, wherein the network node is configured to operate according to a Radio Access Technology (RAT), the computer program product stored on a non-transitory, computer readable medium and comprising program instructions, which when executed by at least one processor, cause the at least one processor to:
receive a reservation signal on a channel in an unlicensed band;
determine whether the signal is according to the RAT, and when the signal is according to the RAT:
decode at least a part of the signal;
determine whether the signal includes embedded information about a duration or end of an intended transmission; and
postpone monitoring of the channel again until the intended transmission is ready.
